(19) United States
(12) Patent Application Publication
(10) Pub. No.: US 2010/0275477 A1
(43) Pub. Date: Nov. 4, 2010

(54) TRANSPARENT DISPLAY BOARD

(76) Inventor: Sung Kyu Kim, Paju-si (KR)

Correspondence Address: PARK LAW FIRM, 3255 WILSHIRE BLVD, SUITE 1110, LOS ANGELES, CA, 90010, US

(21) Appl. No.: 12/085,293

(22) PCT Filed: Aug. 1, 2006
(86) PCT No.: PCT/KR2006/003022

§ 371 Date: Jul. 15, 2010

(30) Foreign Application Priority Data
Nov. 8, 2005 (KR) 10-2005-0106701

(51) Int. Cl. G09F 9/33

(52) U.S. Cl. 40/541

(57) ABSTRACT

A transparent electrically-illuminated sign is disclosed. The transparent electrically-illuminated sign includes a first transparent board, a second transparent which is installed apart from the first transparent board at a certain distance, facing the first transparent board, a plurality of LEDs, a transparent electrode, a filling material which is transparent and filled between the transparent electrode and the second transparent board, and a controller. The transparent electrode is formed on one of both faces of the first transparent board as the transparent electrode is coated thereon, in which the face coated by the first transparent electrode faces the second transparent board. The transparent electrode forms at least more than one close circuit plate which is divided into a cathode plate and a plurality of anode plates. The cathode plate is connected by each cathode lead of the plurality of LEDs, which are separated from each other by a certain distance. The cathode plate forms a cathode power supply terminal at a certain position thereof to input power from the outside. The anode plates are correspondingly connected by the anode leads of the LEDs, respectively. Each of the anode plates forms an anode power supply terminal at a predetermined position thereof to input power from the outside. The controller is connected to the anode power supply terminals, such that it can control power supplied to the cathode and anode plates to turn on and off the LEDs. Therefore, the transparent electrically-illuminated sign configured to be thin and transparent can display moving images, as each LED is turned on and off, consuming low power.

### TECHNICAL FIELD

The present invention relates to an electrically-illuminated sign, and more particularly to a transparent electrically-illuminated sign which is capable of displaying moving letters or images on both display faces thereof, at high levels of brightness, as each of LEDs installed therein is turned on and off.

### BACKGROUND ART

Generally, guide messages or advertisement messages can be conveyed to the public through some means, such as a standing sign or a banner, etc., on which previously designed letters or images are displayed. Although the standing sign and banner, etc., are generally employed as use of message transmission, they have disadvantages in that: they can display only limited contents which have been previously designed; and they require additional electrically-illuminated devices to allow the contents to be visible at night.

There is an another example of an electrically-illuminated sign which can display various colored letters or images thereon, and also provide even moving images thereon, using its own light source, such as LEDs, etc. However the conventional electrically-illuminated sign is disadvantageous in that its thickness is relatively thick because electric wires must be processed therebehind and other elements for implementing moving images must be included therein. More specifically, since circuit boards for driving the LEDs are configured in multi-layers, such configuration causes the conventional electrically-illuminated sign to be thick. Also, since the conventional electrically-illuminated sign generally covers its back with a cover for shielding electric wires, the framework for the cover makes the conventional electrically-illuminated sign thick, and furthermore causes the appearance of the conventional electrically-illuminated sign to diminish.

In order to resolve the above-mentioned problems, there has been an attempt to manufacture a transparent electrically-illuminated sign whose both faces can display guide messages or advertisement messages. Such a transparent electrically-illuminated sign was manufactured such that: letters, pictures or marks, etc., are designed on acrylic plates and then cut therefrom; and light sources are installed to one face or both faces of the acrylic plates to illuminated the acrylic plates. However, the conventional transparent electrically-illuminated sign has disadvantages in that: it cannot display moving images; and images cannot be clearly displayed thereon because they are relatively dark and stains appear on the acrylic plates. Namely, the displayed images are dark, since the images are displayed through the reflected light of the light source. Also, the stains occur on the acrylic plates since the acrylic plates receive different amount of light from the light source according to distances between the acrylic plates and the light source.

### DISCLOSURE

### Technical Problem

Therefore, the present invention has been made in view of the above problems, and it is an object of the present invention to provide a transparent electrically-illuminated sign which is capable of displaying moving images, letters or images, at high levels of brightness, on both display faces thereof, as each of LEDs installed therein is turned on and off using transparent boards and transparent electrodes.

### Technical Solution

The present invention relates to a transparent electrically-illuminated sign comprising: a first transparent board; a second transparent board which is installed apart from the first transparent board at a certain distance, facing the first transparent board; a plurality of LEDs; a transparent electrode which is formed on one of both faces of the first transparent board as the transparent electrode is coated thereon, in which the face coated by the first transparent electrode faces the second transparent board, wherein: the transparent electrode forms at least more than one close circuit plate which is divided into a cathode plate and a plurality of anode plates; the cathode plate is connected by each cathode lead of the plurality of LEDs, which are separated from each other by a certain distance; the cathode plate forms a cathode power supply terminal at a certain position thereof to input power from the outside; the anode plates are correspondingly connected by the anode leads of the LEDs, respectively; each of the anode plates forms an anode power supply terminal at a predetermined position thereof to input power from the outside; a filling material filled between the transparent electrode and the second transparent board, wherein the filling material is transparent; and a controller connected to the anode power supply terminals, wherein the controller controls power supplied to the cathode and anode plates to turn on and off the LEDs.

In addition, according to the present invention, each LED has two electrical leads, emitting a single color light; and the transparent electrode is divided into the cathode plate and the anode plates, such that the cathode power supply terminal of the cathode plate and the anode power supply terminals of the anode plates can be located at one end side of the transparent electrode.

In addition, according to the present invention, each LED has two electrical leads, emitting a single color light; and the transparent electrode is divided into the cathode plate and the anode plates, such that a cathode power supply terminal can be formed at one end of the transparent electrode, and anode power supply terminals corresponding to the anode plates can be divided and aligned at both ends of the transparent electrode, mutually facing to each other.

In addition, according to the present invention, each LED has four electrical leads, emitting different color lights according to a state where the four electrical leads input power; and the transparent electrode is divided into the cathode plate and the anode plates, such that a cathode power supply terminal can be formed at one end of the transparent electrode, and anode power supply terminals corresponding to the anode plates can be divided and aligned at both ends of the transparent electrode, mutually facing to each other.

In addition, according to the present invention, each electrical lead of the LEDs is connected to the transparent electrode by electro-conductive adhesive.

In addition, according to the present invention, the transparent electrode includes non-electro-conductive adhesive to fill in gaps formed as the transparent electrode is divided, so as not to short the both electrodes of a power supply supplying power thereto.

In addition, according to the present invention, the transparent electrode is made of one of Indium Tin Oxide (ITO), Indium Zinc Oxide (IZO) or liquid polymer.

In addition, according to the present invention, the cathode power supply terminal and the anode power supply terminals of the transparent electrode being attached by an electro-conductive adhesive tape for power supply thereto, respectively, and the controller is connected to each of the anode plates by the electro-conductive adhesive tape.

### ADVANTAGEOUS EFFECTS

As appreciated through the above aspects, the present invention has effects as follows:

First, since the transparent electrically-illuminated sign of the present invention does not require circuit boards of multi-layers for driving LEDs or steps for processing electric wires in the back side and for covering the back side with a cover, it can be transparent and relatively thin.

Second, since the transparent electrically-illuminated sign of the present invention controls each of a plurality of LEDs included therein, such that various types of letters or images can be displayed and moving images can be also displayed in a single color or in many colors.

Third, since the transparent electrically-illuminated sign of the present invention can show contents through both faces thereof using transparent boards and transparent electrodes, advertisement effects can be increased. Also, when the transparent electrically-illuminated sign is not operated, it is recognized as a transparent glass plate.

Namely, such an appearance stimulates people's curiosity and highlights its atheistic elements.

### DESCRIPTION OF DRAWINGS

The above and other objects, features and other advantages of the present invention will be more clearly understood from the following detailed description taken in conjunction with the accompanying drawings, in which:

FIG. 1 is a view illustrating an embodiment of a transparent electrically-illuminated sign according to the present invention;

FIG. 2 is a cross-sectional view, which is taken along lines II-II in FIG. 1, for describing coupling relationship among elements in the embodiment of the transparent electrically-illuminated sign according to the present invention;

FIG. 3 is a view illustrating a first embodiment of the transparent electrically-illuminated sign according to the present invention;

FIG. 4 is a view illustrating a second embodiment of the transparent electrically-illuminated sign according to the present invention; and

FIG. 5 is a view illustrating a third embodiment of the transparent electrically-illuminated sign according to the present invention.

### BEST MODE

Preferred embodiments of the present invention will now be described in detail with reference to the annexed drawings.

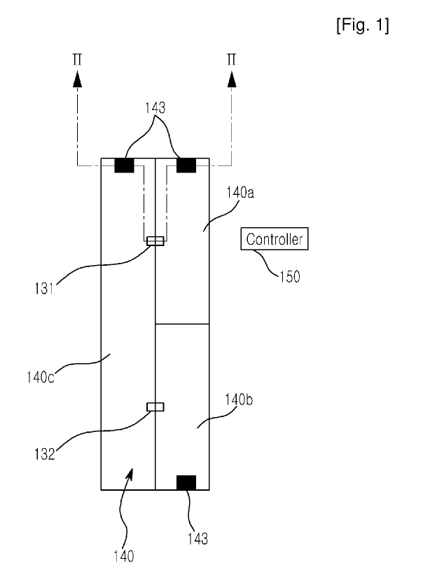

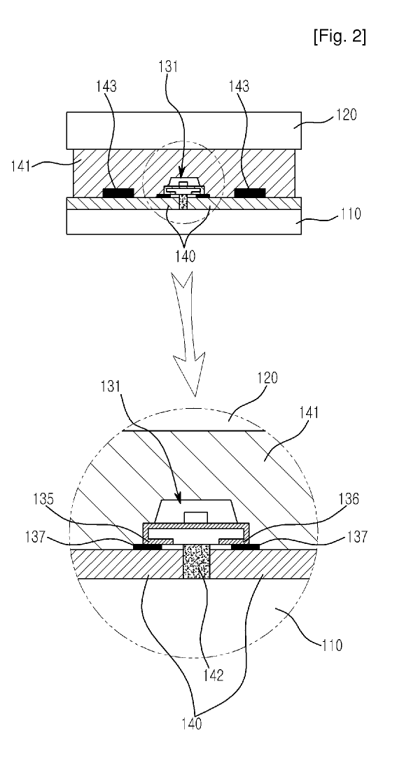

FIG. 1 is a view illustrating an embodiment of a transparent electrically-illuminated sign according to the present invention, and FIG. 2 is a cross-sectional view, which is taken along lines II-II in FIG. 1, for describing coupling relationship among elements in the embodiment of the transparent electrically-illuminated sign according to the present invention. As shown in FIG. 1 and FIG. 2, the transparent electrically-illuminated sign according to the present invention includes a first transparent board 110, a second transparent board 120, light emitted diodes (LEDs) 131 and 132, a transparent electrode 140, a filling material 141, and a controller 150.

The first transparent board 110 serves to determine the outer form of the transparent electrically-illuminated sign.

The second transparent board 120 is installed apart from the first transparent board 110 at a predetermined distance, facing the first transparent board 110. The second transparent board 120 is manufactured such that its size can be the same as the size of the first transparent board 110. The LEDs 131 and 132, the transparent electrode 140, and the filling material are located between the first and second transparent boards 110 and 120. The first and second transparent boards 110 and 120 can be made of one of glass plate made of transparent materials, acrylic, and Poly Carbonate (PC). Here, when the glass plate having relatively weak strength is adopted thereto, the degree of transparency is decreased or the glass plate may be broken, due to scratches etc. On the other hand, when the glass plate whose strength is too high is adopted thereto, the glass plate can be prevented from bending, and resistance of the transparent electrode 140 can be increased. Therefore, the glass plate with proper strength must be selected to comply with installation purpose and installation place of the electrically-illuminated sign.

The LEDs 131 and 132 as light emitting devices can emit lights as power is applied thereto. When a plurality of LED's are installed on a plate, they can express various types of letters of images as they are turned on and off as power is applied thereto, respectively.

The transparent electrode 140 is formed on one of both faces of the first transparent board 110 as it is coated thereon, in which the face coated by the first transparent electrode 110 faces the second transparent board 120, such that the transparent electrode 140 is located between the first and second transparent boards 110 and 120. The transparent electrode 140 forms at least one closed circuit plate (140a, 140b, and 140c) which is divided into a cathode plate 140c and a plurality of anode plates 140a and 140b. The cathode plate 140c is connected by each cathode lead 135 of the LEDs 131 and 132, which are separated from each other by a certain distance, as shown in FIG. 1. The cathode plate 140c forms a cathode power supply terminal 143 at a predetermined position thereof to input power from the outside. The anode plate 140a is connected by the anode lead 136 of the LED 131, and the anode plate 140b is connected by the anode lead 136 of the LED 132. Each of the anode plates 140a and 140b forms an anode power supply terminal 143 at a predetermined position thereof to input power from the outside. When the transparent electrode 140 is divided into the cathode plate 140c and the anode plates 140a and 140b, the shapes of the divided plates (the cathode plate and the anode plates) may be variously formed. Namely, as the transparent electrode is divided to form various shapes by division, a plurality of LEDs including the LEDs 131 and 132 can be relatively closely aligned each other, and the controller 150 can be relatively easily connected thereto. FIG. 1 illustrates one of the embodiments.

The transparent electrode 140 may be implemented by one of Indium Tin Oxide (ITO), Indium Zinc Oxide (IZO), and liquid polymer (conductive polymer compounds). Preferably, the transparent electrode 140 can be made of materials whose transparency is high and whose surface resistance is low.

On the other hand, the cathode and anode power supply terminals may be implemented as an electro-conductive adhesive tape 143 for supplying power is attached to the cathode and anode plates of the transparent electrode, respectively. The electro-conductive adhesive tape 143 can be made of copper, aluminum, and silver paste, etc.

The cathode leads 135 and the anode leads 136 of the LEDs 131 and 132 can be connected to the transparent electrodes 140 by an electro-conductive adhesive 137. The electro-conductive adhesive 137 may be implemented with silver conductor or silver paste, etc. Preferably, the electro-conductive adhesive 137 may employ materials whose adhesive force is large but whose surface resistance is minimally low. When the filling material 141 is filled up therebetween, it may react with and melt the electro-conductive adhesive 137 such that the leads 135 and 136 of the LEDs 131 and 132 can be separated from the transparent electrodes 140. Therefore, the electro-conductive adhesive 137 must have characteristics that it is not reacted with and melted by solvent of a series of solvent after it is solidified.

Also, the gaps among the closed circuit plates 140a, 140b, and 140c (i.e., the transparent electrodes 140) may be filled with non-electro-conductive adhesive 142 to prevent an electrical short between negative and positive poles of power supplied thereto.

The filling material 141 is a kind of adhesive which is filled between the transparent electrode 140 and the second transparent board 120 to perform a protecting function for the LEDs 131 and 132 and an adhering function so that the first and second transparent boards 110 and 120 cannot be separated from each other. In addition, the filling material 141 has a characteristic that it is transparent such that the lights emitted from the LEDs 131 and 132 can transmit therethrough. To this end, the filling material 141 may be implemented by transparent silicon, etc.

The controller 150 is connected to the anode power supply terminal to control power supplying to the cathode plate 140c and the anode plates 140a and 140b, such that the LEDs 131 and 132 can be turned on and off. Here, the controller 150 may be connected to each of the anode plates 140a and 140b using the electro-conductive adhesive tape 143 for power supply.

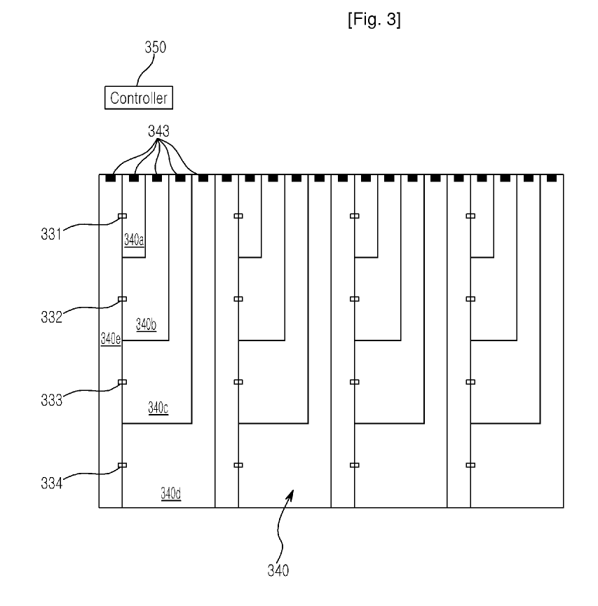

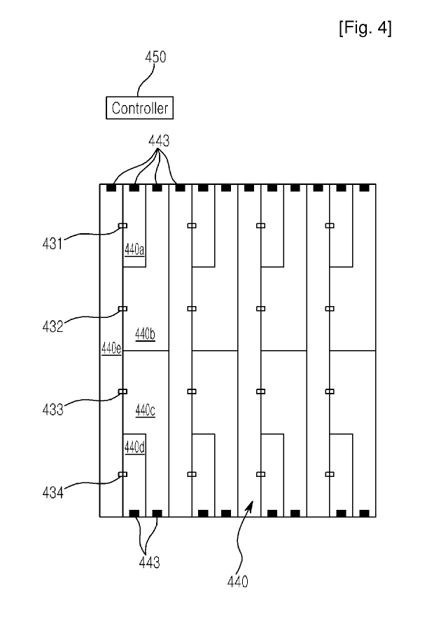

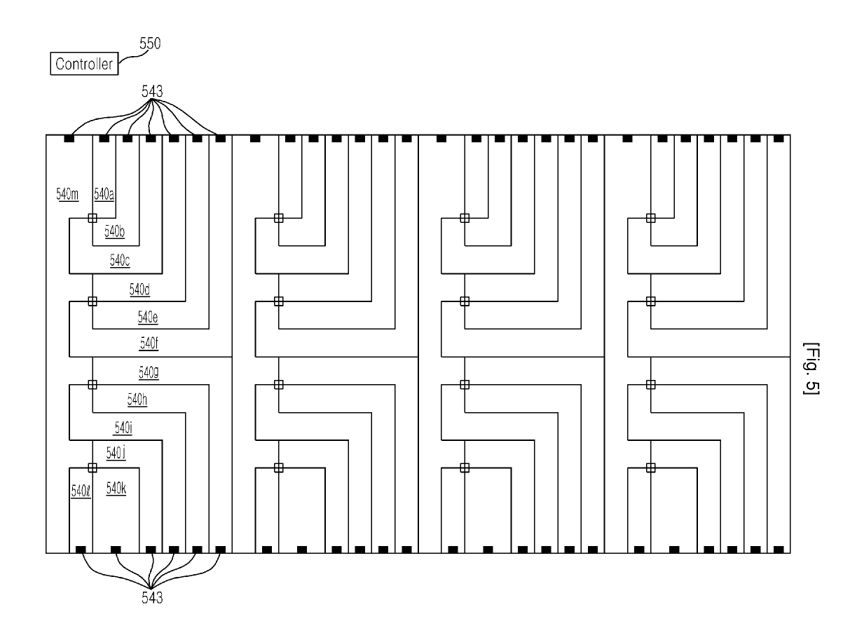

On the other hand, since there are various types of LEDs, the present invention can employ the types of LEDs for the intended use. FIG. 3 and FIG. 4 are first and second embodiments of the transparent electrically-illuminated sign according to the present invention, employing the LEDs each of which has two electrical leads and emits a single color light. FIG. 5 is a third embodiment of the transparent electrically-illuminated sign according to the present invention, employing the LEDs each of which has four electrical leads and emits different color lights according to a state of whether each electrical lead inputs power. The following is descriptions for the embodiment of FIG. 3 to FIG. 5, in which types of the LEDs and division patterns of the transparent electrode are changed, but omits descriptions for other elements which have been already described above.

### Embodiment 1

Referring to FIG. 3, the transparent electrically-illuminated sign according to the first embodiment of the present invention includes a plurality of LEDs 331, 332, 333, and 334 each of which has two electrical leads and emits a single color light. A transparent electrode 340 is divided into a cathode plate 340e on one end of which a cathode power supply terminal is formed, and anode plates 340a, 340b, 340c, and 340d on each end of which an anode power supply terminal is formed. Namely, the cathode and anode power supply terminals are located at the same side of the transparent electrode 340. More specifically, the transparent electrode 340 is divided such that: the cathode plate 340e can be aligned at the left part thereof with respect to FIG. 3; the anode plates 340a, 340b, 340c, and 340d are aligned at the right part thereof with respect to FIG. 3; and the cathode and anode power supply terminals are all aligned at the upper part thereof with respect to FIG. 3. Also, an electro-conductive adhesive tape 343 for power supply is attached to the cathode and anode power supply terminals such that the cathode and anode power supply terminals can receive power therethrough. More specifically, as shown in FIG. 3, in the transparent electrically-illuminated sign according to the first embodiment of the present invention, the transparent electrode 340 forms four closed circuit plates (340a, 340b, 340c, 340d, and 340e) which are divided into a cathode plate 340e, and a plurality of anode plates 340a, 340b, 340c and 340d (first anode plate 340a, second anode plate 340b, third anode plate 340c and fourth anode plate 340d). The cathode plate 340e is connected by each cathode lead of four LEDs (first LED 331, second LED 332, third LED 333 and fourth LED 334). Each of the anode plates 340a, 340b, 340c and 340d is correspondingly connected by each anode lead of the four LEDs 331, 332, 333, and 334, respectively.

When power is supplied to only the first anode plate 340a through the electro-conductive adhesive tape 343 for power supply according to control of the controller 350, only the first LED 331 inputs the power and then emits light. Also, when power is sequentially supplied to the first anode plate 340a and the second anode plate 340b through the electro-conductive adhesive tape 343 according to control of the controller 350, the first LED 331 and the second LED 332 also emit lights in order. Therefore, the transparent electrically-illuminated sign of the first embodiment of the present invention can display a certain letter or image, etc., as well as moving images, thereon, as the controller 350 controls the respective LEDs so as to emit lights.

In addition, the transparent electrically-illuminated sign according to the first embodiment can be easily connected with the controller 350 because the cathode and anode power supply terminals are all aligned at one side of the transparent electrode 340 to input power. Also, the transparent electrically-illuminated sign can be modified such that another close circuit plates can be formed at the opposite side of the transparent electrode 340 being symmetrical with respect to the closed circuit plates 340a, 340b, 340c and 340d.

On the other hand, since the plurality of LEDs must be operated to display moving images, they must be aligned maintaining a predetermined distance thereamong as they are located on a checkerboard.

### Embodiment 2

Referring to FIG. 4, the transparent electrically-illuminated sign according to the second embodiment of the present invention includes a plurality of LEDs 431, 432, 433 and 434 each of which has two electrical leads and emits a single color light. A transparent electrode 440 is divided into a cathode plate 440e, which forms a cathode power supply terminal at one end thereof, and anode plates 440a, 440b, 440c and 440d, in which anode power supply terminals corresponding to the anode plates 440a, 440b, 440c and 440d are divided and aligned at both ends of the transparent electrode 440, mutually facing to each other. More specifically, the transparent electrode 440 is divided, such that the cathode plate 440e is aligned at the left part thereof with respect to FIG. 4 and the anode plates 440a, 440b, 440c and 440d are aligned at the right part thereof with respect to FIG. 4. The anode power supply terminals may be formed at both ends of the transparent electrode 440 (at upper and lower sides of the transparent electrode 440 with respect to FIG. 4) such that the electrical leads of the LEDs 431, 432, 433 and 434 can be relatively closely located thereat, respectively. Here, the electrical leads of the LEDs 431, 432, 433 and 434 are connected to the anode plates 440a, 440b, 440c and 440d, respectively. Also, the electro-conductive adhesive tape 443 for power supply is attached to the cathode and anode power supply terminals such that the cathode and anode power supply terminals can receive power therethrough. Also, as shown in FIG. 4, in transparent electrically-illuminated sign according to the second embodiment of the present invention, the transparent electrode 440 forms four closed circuit plates 440a, 440b, 440c, 440d, and 440e which are divided into a cathode plate 440e and a plurality of anode plates 440a, 440b, 440c and 440d. Here, the cathode plate 440e is connected by each cathode lead of four LEDs (first LED 431, second LED 432, third LED 433, and fourth LED 434). Each of the anode plates 440a, 440b, 440c and 440d is correspondingly connected by each anode lead of the four LEDs 431, 432, 433, and 434, respectively.

When power is supplied to only the first anode plate 440a through the electro-conductive adhesive tape 443 for power supply according to control of the controller 450, only the first LED 431 inputs the power and then emits light. Also, when power is sequentially supplied to the first anode plate 440a and the second anode plate 440b through the electro-conductive adhesive tape 443 according to control of the controller 450, the first LED 431 and the second LED 432 also emit lights in order. Therefore, the transparent electrically-illuminated sign of the second embodiment of the present invention can display a certain letter or image, etc., as well as moving images, thereon, as the controller 450 controls the respective LEDs so as to emit lights.

In addition, the transparent electrically-illuminated sign according to the second embodiment can reduce widths of the closed circuit plates 440a, 440b, 440c, 440d and 440e, since the cathode and anode power supply terminals are not aligned at one end of the transparent electrode 440 but at both ends thereof. Therefore, the space among the LEDs adjacent to the same row can be also reduced.

On the other hand, since the plurality of LEDs must be operated to display moving images, they must be aligned maintaining a predetermined distance thereamong as they are located on a checkerboard.

### Embodiment 3

Referring to FIG. 5, the transparent electrically-illuminated sign according to the third embodiment of the present invention includes a plurality of LEDs 531, 532, 533 and 534 each of which has four electrical leads and emits different color lights according to a state as to whether the four electrical leads input power. A transparent electrode 540 is divided into a cathode plate 540m, and anode plates 540a, 540b, 540c, 540d, 540e, 540f, 540g, 540h, 540i, 540j, 540k, and 540l, in which the anode power supply terminals corresponding to the anode plates 540a, 540b, 540c, 540d, 540e, 540f, 540g, 540h, 540i, 540j, 540k, and 540l is divided and aligned at both ends of the transparent electrode 540, mutually facing to each other. More specifically, the transparent electrode 540 is divided, such that the cathode plate 540m is aligned at the left part thereof with respect to FIG. 5 and the anode plates 540a, 540b, 540c, 540d, 540e, 540f, 540g, 540h, 540i, 540j, 540k, and 540l are aligned at the right part thereof with respect to FIG. 5. The anode power supply terminals may be formed at both ends of the transparent electrode 540 (at upper and lower sides of the transparent electrode 540 with respect to FIG. 5) such that the electrical leads of the LEDs 531, 532, 533 and 534 can be relatively closely located thereat, respectively. Also, the electro-conductive adhesive tape 543 for power supply is attached to the cathode and anode power supply terminals such that the cathode and anode power supply terminals can receive power therethrough. Also, as shown in FIG. 5, in transparent electrically-illuminated sign according to the third embodiment of the present invention, the transparent electrode 540 forms a plurality of closed circuit plates 540a, 540b, 540c, 540d, 540e, 540f, 540g, 540h, 540i, 540j, 540k, 540l, and 540m which are divided into a cathode plate 540m and a plurality of anode plates 540a, 540b, 540c, 540d, 540e, 540f, 540g, 540h, 540i, 540j, 540k, and 540l. Here, the cathode plate 540m is connected by each cathode lead of four LEDs (first LED 531, second LED 532, third LED 533, and fourth LED 534). Each of the anode plates 540a, 540b, 540c, 540d, 540e, 540f, 540g, 540h, 540i, 540j, 540k, and 540l is correspondingly connected by each anode lead of the four LEDs 531, 532, 533, and 534, respectively.

When power is supplied to only the first anode plate 540a through the electro-conductive adhesive tape 543 for power supply according to control of the controller 550, the first LED 531 emits light (for example, red light) according to power supplied to the electrical lead of the first LED 531 connected to the first anode plate 540a. Also, when power is supplied to the second anode plate 540b through the electro-conductive adhesive tape 543 according to control of the controller 550 in a state where power is supplied to the first anode plate 540a, the first LED 531 emits light (for example, whose color is created by combining red light and green light) according to powers supplied to the electrical leads connected to the first anode plate 540a and the second anode plate 540b. Therefore, the transparent electrically-illuminated sign of the third embodiment of the present invention can display a certain colored letter or image, etc., as well as moving images, thereon, as the controller 550 controls the respective LEDs such that they can emit various color lights.

In addition, the transparent electrically-illuminated sign according to the third embodiment can reduce widths of the closed circuit plates, since the cathode and anode power supply terminals are not aligned at one end of the transparent electrode 540 but at both ends thereof. Therefore, the space among the LEDs adjacent to the same row can be also reduced.

On the other hand, since the plurality of LEDs must be operated to display moving images, they must be aligned maintaining a predetermined distance thereamong as they are located on a checkerboard.

### INDUSTRIAL APPLICABILITY

The transparent electrically-illuminated sign according to the present invention can be efficiently used in the advertisement fields as letters or images are displayed on both display faces at high levels of brightness while each of LEDs installed on both display faces is turned on and off.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A transparent electrically-illuminated sign comprising:
a first transparent board;
a second transparent board which is installed apart from the first transparent board at a certain distance, facing the first transparent board;
a plurality of LEDs;
a transparent electrode which is formed on one of both faces of the first transparent board as the transparent electrode is coated thereon, in which the face coated by the first transparent electrode faces the second transparent board, wherein: the transparent electrode forms at least more than one close circuit plate which is divided into a cathode plate and a plurality of anode plates; the cathode plate is connected by each cathode lead of the plurality of LEDs, which are separated from each other by a certain distance; the cathode plate forms a cathode power supply terminal at a certain position thereof to input power from the outside; the anode plates are correspondingly connected by the anode leads of the LEDs, respectively; each of the anode plates forms an anode power supply terminal at a predetermined position thereof to input power from the outside;
a filling material filled between the transparent electrode and the second transparent board, wherein the filling material is transparent; and
a controller connected to the anode power supply terminals, wherein the controller controls power supplied to the cathode and anode plates to turn on and off the LEDs.

2. The transparent electrically-illuminated sign according to claim 1, wherein:
each LED has two electrical leads, emitting a single color light; and
the transparent electrode is divided into the cathode plate and the anode plates, such that the cathode power supply terminal of the cathode plate and the anode power supply terminals of the anode plates can be located at one end side of the transparent electrode.

3. The transparent electrically-illuminated sign according to claim 1, wherein:
each LED has two electrical leads, emitting a single color light; and
the transparent electrode is divided into the cathode plate and the anode plates, such that a cathode power supply terminal can be formed at one end of the transparent electrode, and anode power supply terminals corresponding to the anode plates can be divided and aligned at both ends of the transparent electrode, mutually facing to each other.

4. The transparent electrically-illuminated sign according to claim 1, wherein:
each LED has four electrical leads, emitting different color lights according to a state where the four electrical leads input power; and
the transparent electrode is divided into the cathode plate and the anode plates, such that a cathode power supply terminal can be formed at one end of the transparent electrode, and anode power supply terminals corresponding to the anode plates can be divided and aligned at both ends of the transparent electrode, mutually facing to each other.

5. The transparent electrically-illuminated sign according to claim 1, wherein each electrical lead of the LEDs is connected to the transparent electrode by electro-conductive adhesive.

6. The transparent electrically-illuminated sign according to claim 1, wherein the transparent electrode includes non-electro-conductive adhesive to fill in gaps formed as the transparent electrode is divided, so as not to short the both electrodes of a power supply supplying power thereto.

7. The transparent electrically-illuminated sign according to claim 1, wherein the transparent electrode is made of one of Indium Tin Oxide (ITO), Indium Zinc Oxide (IZO) or liquid polymer.

8. The transparent electrically-illuminated sign according to claim 1, wherein the cathode power supply terminal and the anode power supply terminals of the transparent electrode being attached by an electro-conductive adhesive tape for power supply thereto, respectively, and the controller is connected to each of the anode plates by the electro-conductive adhesive tape.

9. The transparent electrically-illuminated sign according to claim 2, wherein each electrical lead of the LEDs is connected to the transparent electrode by electro-conductive adhesive.

10. The transparent electrically-illuminated sign according to claim 2, wherein the transparent electrode includes non-electro-conductive adhesive to fill in gaps formed as the transparent electrode is divided, so as not to short the both electrodes of a power supply supplying power thereto.

11. The transparent electrically-illuminated sign according to claim 2, wherein the transparent electrode is made of one of Indium Tin Oxide (ITO), Indium Zinc Oxide (IZO) or liquid polymer.

12. The transparent electrically-illuminated sign according to claim 2, wherein the cathode power supply terminal and the anode power supply terminals of the transparent electrode being attached by an electro-conductive adhesive tape for power supply thereto, respectively, and the controller is connected to each of the anode plates by the electro-conductive adhesive tape.

13. The transparent electrically-illuminated sign according to claim 3, wherein each electrical lead of the LEDs is connected to the transparent electrode by electro-conductive adhesive.

14. The transparent electrically-illuminated sign according to claim 3, wherein the transparent electrode includes non-electro-conductive adhesive to fill in gaps formed as the transparent electrode is divided, so as not to short the both electrodes of a power supply supplying power thereto.

15. The transparent electrically-illuminated sign according to claim 3, wherein the transparent electrode is made of one of Indium Tin Oxide (ITO), Indium Zinc Oxide (IZO) or liquid polymer.

16. The transparent electrically-illuminated sign according to claim 3, wherein the cathode power supply terminal and the anode power supply terminals of the transparent electrode being attached by an electro-conductive adhesive tape for power supply thereto, respectively, and the controller is connected to each of the anode plates by the electro-conductive adhesive tape.

17. The transparent electrically-illuminated sign according to claim 4, wherein each electrical lead of the LEDs is connected to the transparent electrode by electro-conductive adhesive.

18. The transparent electrically-illuminated sign according to claim 4, wherein the transparent electrode includes non-electro-conductive adhesive to fill in gaps formed as the transparent electrode is divided, so as not to short the both electrodes of a power supply supplying power thereto.

19. The transparent electrically-illuminated sign according to claim 4, wherein the transparent electrode is made of one of Indium Tin Oxide (ITO), Indium Zinc Oxide (IZO) or liquid polymer.

20. The transparent electrically-illuminated sign according to claim 4, wherein the cathode power supply terminal and the anode power supply terminals of the transparent electrode being attached by an electro-conductive adhesive tape for power supply thereto, respectively, and the controller is connected to each of the anode plates by the electro-conductive adhesive tape.
